(19) United States
(12) Patent Application Publication
(10) Pub. No.: US 2007/0124767 A1
(43) Pub. Date: May 31, 2007

(54) System for determining return on investment from television and on-line marketing communications

(76) Inventors: Marlene Laskowski-Bender, Austin, TX (US); Matthew Floyd, Austin, TX (US); Vishal Jhaveri, Austin, TX (US)

Correspondence Address: HAMILTON & TERRILE, LLP, P.O. BOX 203518, AUSTIN, TX, 78720, US

(21) Appl. No.: 11/268,378

(22) Filed: Nov. 7, 2005

(51) Int. Cl. H04N 5/445; G06F 13/00; G06F 3/00

(52) U.S. Cl. 725/42

(57) ABSTRACT

A method of determining effectiveness of television and on-line marketing communications is disclosed. A method for determining when transference occurs between different marketing vehicles is also disclosed. The method uses a modular system for determining effectiveness of marketing communications which provides an efficient and timely process for measuring the effectiveness of marketing activities. The system is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities.

### BACKGROUND OF THE INVENTION

1. Field of the Invention

The present invention relates to the field of marketing communications and more particularly to determining effectiveness for television and on-line marketing communications.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue relating to information handling systems and to marketing in general relates to determining return on investment for marketing communication (marcom) expense. It is desirable for marketers and companies using marketers to have a precise measurement and proven return on investment to determine which types of marketing communication provide a desirable return on money spent for the marketing.

Advertising agencies and other types of marketers are being required to provide metrics that show real interactions by specific customers. This type of data is relatively easy to generate for some marketing mediums, such as the Internet. However, this same type of data can be somewhat difficult to obtain from other types of marketing mediums such as television and print.

Known methods for determining return on investment from marketing communications present a plurality of limitations. For example, know methods have a limited ability to effectively and efficiently measure a return on marketing communication expenditures. Known methods lack standardization and automation of the various information and range of marketing vehicles that is desired for determining a return on marketing communication expenditures. Known methods use extraneous processes for data gathering, integration and manipulation and these extraneous processes may be from disparate data sources (both internal data sources and external data sources.

Known methods thus present a challenge in not providing timely metrics regarding marketing communication effectiveness. Known methods have an inability to easily apply overlay and statistical applications to result sets of efficiency measures. Additionally, known methods do not provide the ability to track the effectiveness of marketing communications for television marketing communications and on-line marketing communications.

Known methods also present a challenge when a customer purchase a product via a mechanism which is different from the marketing communication that drove the purchase. This type of action is referred to as transference between different types of marketing communications. Thus, a customer might purchase an item via an on-line web site based upon a direct marketing type marketing communication or a television type marketing communication. It is desirable to have the ability to attribute the sale to the type of marketing communication that drove the sale. I.e., when one type of marketing communication functions as a driver to cause a consumer to purchase an item via another type of marketing communication.

Accordingly, it is desirable to provide a system for determining effectiveness of marketing communications for television and on-line marketing communications. It is also desirable to determine when transference occurs between different marketing vehicles.

### SUMMARY OF THE INVENTION

In accordance with the present invention, a method of determining effectiveness of television and on-line marketing communications is disclosed. A method for determining when transference occurs between different marketing vehicles is also disclosed. The method uses a modular system for determining effectiveness of marketing communications which provides an efficient and timely process for measuring the effectiveness of marketing activities. The system is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities.

In one embodiment, the invention relates to a method for analyzing television marketing communication effectiveness which includes providing a television marketing communication with identification information, price information and product information for a primary product and a secondary product, linking an order with the television marketing communication via the marketing communication identification information, and determining, via a marketing communication system, marketing communication effectiveness for the television marketing communication.

In another embodiment, the invention relates to a method for analyzing online marketing communication effectiveness which includes providing an online marketing communication with identification information, price information and product information for a primary product and a secondary product, linking an order with the online marketing communication via the marketing communication identification information, and determining, via a marketing communication system, marketing communication effectiveness for the online marketing communication.

In another embodiment, the invention relates to an apparatus for analyzing television marketing communication effectiveness which includes means for providing a television marketing communication with identification information, price information and product information for a primary product and a secondary product, means for linking an order with the television marketing communication via the marketing communication identification information, and a marketing communication system which determines marketing communication effectiveness for the television marketing communication.

In another embodiment, the invention relates to an apparatus for analyzing online marketing communication effectiveness which includes means for providing an online marketing communication with identification information, price information and product information for a primary product and a secondary product, means for linking an order with the online marketing communication via the marketing communication identification information, and a marketing communication system which determines marketing communication effectiveness for the online marketing communication.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a marketing communications environment.

FIG. 2 shows a flow diagram of the operation of a marketing communication return on investment tool.

FIG. 3 shows a block diagram of a marketing communication return on investment system.

FIG. 4 shows a block diagram of the process flow of order attribution within the marcom ROI system.

FIG. 5 shows a flow diagram of inputs to and outputs from the marketing communication return on investment system.

FIG. 6 shows a block diagram of an example of the operation of the marcom return on investment system.

FIG. 7 shows an example print marketing communication.

FIG. 8 shows an example of a screen presentation for a television marketing communication.

FIG. 9 shows another example of a screen presentation of a television marketing communication.

FIG. 10 shows another example of a screen presentation of a television marketing communication.

FIG. 11 shows an example of an online marketing communication.

FIG. 12 shows another example of an online marketing communication.

FIG. 13 shows another example of an online marketing communication.

FIG. 14 shows another example of an online marketing communication.

FIG. 15 shows a system block diagram of an information handling system for executing a marketing communication return on investment system.

FIG. 16 shows a block diagram of an alternate process flow of order attribution within the marcom ROI system.

### DETAILED DESCRIPTION

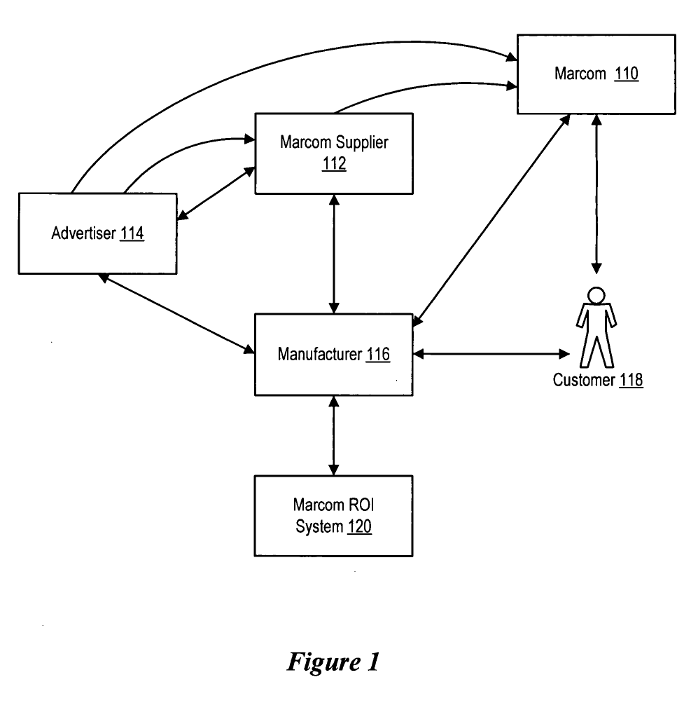

Referring to FIG. 1, a block diagram of a marketing communications environment 100 is shown. More specifically, a marketing communication environment 100 includes a marketing communication (marcom) 110, a marcom supplier 112, an advertiser 114 a manufacturer 116 and a customer 118. The marketing communication environment also includes a marketing communication return on investment (marcom ROI) system 120.

The marketing communication 110 may be any type of communication which presents marketing information to the customer 118 including television marcom, print marcom, direct mail marcom and internet based marcom.

In general, the advertiser 114 develops the marcom 110 to market a product produced or supplied by the manufacturer 116. The marcom is then distributed either directly by the advertiser 114 or via a marcom supplier 112. A customer 118 purchases a product based upon the marcom 110. In variations of the marketing communications environment 110, the manufacturer may develop the marcom 110 and either distribute the marcom 110 via the marcom supplier 112 or directly distribute the marcom 110. Additionally, various entities may be merged. So for example, the advertiser 114 may be part of the manufacturer 116, the marcom supplier 112 may be part of the advertiser 114 and any other combination of the entities. Additionally, the manufacturer is considered to be any supplier of a product or service for which marketing communications are used to communicate with a customer.

The manufacturer 116 can use the marcom ROI system 120 to determine the effectiveness of the marcom 110. The manufacturer 116 receives information from the marcom 110, the marcom supplier 112 and the advertiser 114 for use with the marcom ROI system 120.

The marcom ROI system 120 is a modular system for determining return on investment from marketing communications. The marcom ROI system 120 provides an efficient and timely process for measuring the effectiveness of marketing activities. The marcom ROI system 120 is modular so that certain functions may be selectively added based upon the type of marketing communications for which return on investment is to be tracked. Additionally, certain functions may be added to the system based upon the type of information and the level of detail of the information that the system provides regarding the effectiveness of marketing activities. Thus, the modular system minimizes data integration and manipulation of metrics regarding marketing communications and expedites the generation of metrics regarding the effectiveness of marketing communications. By being modular, the marcom ROI system 120 is scalable by segment (i.e., a business unit or profit and loss center) and by marcom vehicle (i.e., a type of marcom). Such a modular system provides efficiency in terms of processing to link all of the various orders due to the volume of data. Such a scalable modular system can add or remove segments or vehicles without adversely affecting the operation of the marcom ROI system 120.

The marcom ROI system 120 resides within and executes on a data warehouse environment to provide the marcom ROI system 120 with enough processing power to receive and manipulate the amounts of marcom information provided by the various entities within the marketing communications environment as well as customer and order information for providing meaningful analysis of the information. The data warehouse is a substantially company wide data base and associated processing power that supports decision making within the organization. The data warehouse is structured to support a variety of analysis including elaborate queries on large amounts of data that require extensive searching. Data warehouse can support the storage of hundreds of gigabytes of data.

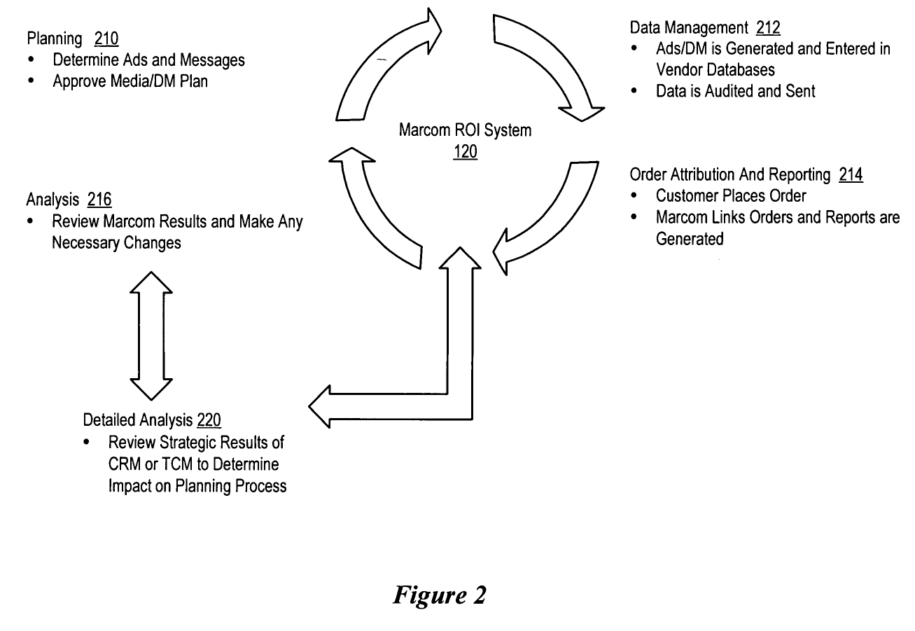

FIG. 2 shows a flow diagram of the operation of a marketing communication return on investment system 120. More specifically, operation of the marcom ROI system 120 includes a planning phase 210, a data management phase 212, an order attribution and reporting phase 214 and an analysis phase 216.

During the planning phase 210, the manufacturer 116 and one or more advertising agencies, including possibly a virtual agency (VA), or marketing suppliers determine the content of marketing communication as well as a plan for distributing the marketing communication and approve the communication and plan. During the data management phase 212 the marketing communication is generated and data about the marketing communication is entered into the database of the entity generating the marketing communication. Additionally, the data is audited and provided to the marcom ROI system 120. During the order attribution and reporting phase 214, data is generated when a customer 118 places an order. The marcom ROI system 120 links orders placed with particular marketing communications and generates reports based upon this linking. During the analysis phase 216, the manufacturer 116 reviews the results of the marketing communications and makes any necessary or desirable changes to the marketing communication. The planning phase 210 then starts again using the information developed during the analysis phase 216.

Additionally, the marcom ROI system 120 may be used to perform detailed analysis 220 in addition to the analyses that are performed during the analysis phase 216. For example, results from the marcom ROI analysis can be merged with results from customer response management (CRM) (which provides detailed customer information) or total cost of marcom (TCM) (which includes all customer related expenditures including customer care calls or technical support calls) are reviewed to determine whether there should be an impact on the planning process.

By providing a centralized marcom ROI system 120, marcom effectiveness can be evaluated across multiple marcom vehicles. Additionally the effect of featured products and promotions can be evaluated on an individual and collective basis.

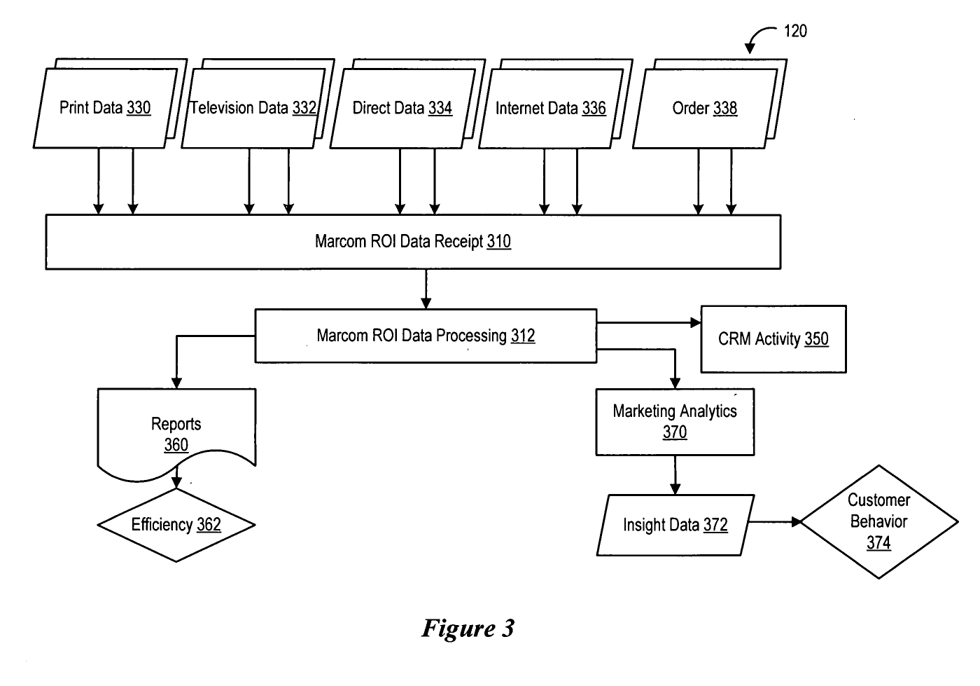

FIG. 3 shows a block diagram of a modular marketing communication return on investment system 120. More specifically, the marcom ROI system 120 includes a centralized marcom ROI data receipt module 310 and a marcom ROI data processing module 312. The centralized marcom ROI data receipt module 310 provides a central repository into which marcom data is received. The marcom ROI data receipt module 310 audits the received data to assure the quality of the data provided by the marcom sources.

The centralized marcom ROI data receipt module 310 provides the accumulated data to the marcom ROI data processing module 312. The marcom ROI data processing module 312 receives the data from the centralized marcom ROI data receipt module 310, links the received marcom data and populates results based upon the linked marcom data (e.g. magazine type print marcom or specific television network marcom linked to a particular order number).

The marcom ROI system 120 includes data from one or more of a plurality of marcom sources. For example, the data may include print marcom data 330, television marcom data 332, direct mail marcom data 334 and internet marcom data 336. The data is provided to the centralized marcom data receipt module 310. Additionally, the marcom ROI system 120 includes data from one or more order sources 338. Because the marcom ROI system 120 is modular, one or more of these data sources may be included within the marcom ROI system 120 based upon which types of marcom data are being analyzed. Additionally, more than one source may provide each type of data. So for example, the marcom ROI data receipt module 310 may receive data from two print data sources

The marcom ROI system 120 can interact with a CRM activity module 350. The CRM activity module 350 receives information from the marcom ROI data processing module 312 analyzes the processed marcom data along with CRM information.

The linked data results generated by the marcom ROI data processing module 312 may be provided to a plurality of sources via a data feed. The linked data results may be used to generate reports (including electronic reports and hard copy reports) via a reports module 360. The reports may be periodically generated such as reports that are generated weekly. The reports can be used to determine the efficiency 362 of the various marcom.

The linked data results 352 are also used to generate marketing analytics information via a marketing analytics module 370. The marketing analytics information includes customer insight data 372 such as first purchase marcom vehicle preference and second purchase marcom vehicle preference, effective acquisition marcom vehicle, or retention marcom vehicle. The insight data 372 provides insight into customer behavior 374.

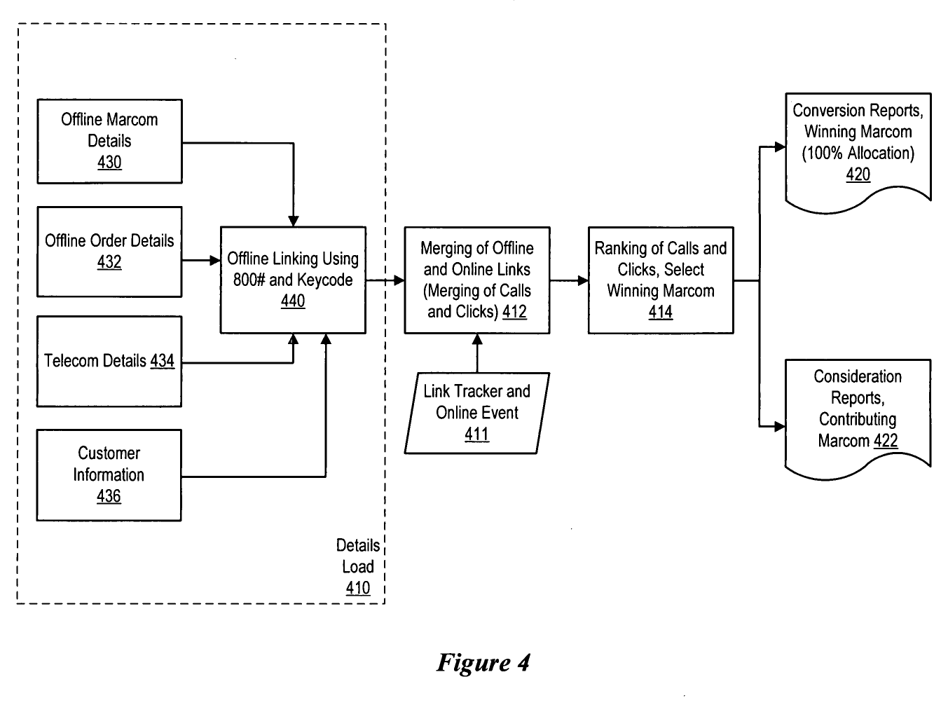

Referring to FIG. 4, a block diagram of the process flow of order attribution within the marcom ROI system 120 is shown. The process starts with an offline marcom details load process at step 410 as well as online event information details from, e.g., an online order attribution application, at step 411. The marcom system 120 merges offline details and the online link details at step 412.

During the marcom load, the marcom ROI system 120 determines which marcom to link with which orders using for example, the telephone numbers (e.g., various 800 numbers) used when interacting with the manufacturer, keycodes identified when interacting with the manufacturer or a vanity url (e.g., dell.com/tv) when interacting with the manufacturer.

Next the process identifies orders to link at step 412. During the identification step 412, the marcom ROI system 120 determines which orders to link for a predetermined amount of time. For example, the identification step may determine what new orders have been added since the last time that the system performed a link operation and whether there are any orders that need to be re-linked.

When determining the online event information details, the marcom system 120 may use a process such as an online order attribution application. The online order attribution application identifies orders that have been established and identifies any clicks that led up to the order. The linking may also include associating a key code with the marcom. The linking may also track information including affiliates or emails that result in an order.

Next, at step 414, the marcom ROI system 120 generates a ranking of various marcom candidates (e.g., calls and clicks) to provide an indication of a winning marcom. The winning marcom is selected from a list of marcom candidates based upon a plurality of factors such as recency (a marcom vehicle that is closes to the order in terms of time and day) and business rules for each of the marcom candidates.

When ranking the various marcom candidates, the marcom ROI system 120 identifies the contacts leading up to the order (i.e., the contacts that factored into the consideration of the customer making a purchase). For example, with an internet type marcom, the contacts might include select clicks leading up to the order from online order attribution application (for online orders), select calls leading up to the order (for online and offline type orders). These marcom related calls or clicks that are identified as consideration (that were part of a customer's decision making process), and code links that are not selected as a winner are identified as consideration data (e.g., this information may be inserted into a consideration table).

The ranking generated at step 414 can be used to generate conversion reports 420 as well as consideration reports 422. The conversion reports 420 indicate a winning marcom when considering substantially all related marcom candidates (i.e., with 100% allocation). The consideration reports 422 takes into account contributing marcom. For example, a certain type of marcom might have resulted in a sale, while other types of marcom were presented to a particular customer and are assumed to have contributed to the sale.

During the details load step 410, the marcom system receives information from a variety of offline sources and links the information to the appropriate marcom. More specifically, the marcom system 120 receives offline marcom details 430, offline order details 432, telecom details 434 as well as customer information 436 and links this information using call in number information (such as 800 number information) and keycode information at step 440. Different marcom vehicles present different call in numbers or keycodes. Thus, based upon particular call in numbers and keycodes, a customer contact may be linked to a particular marcom vehicle.

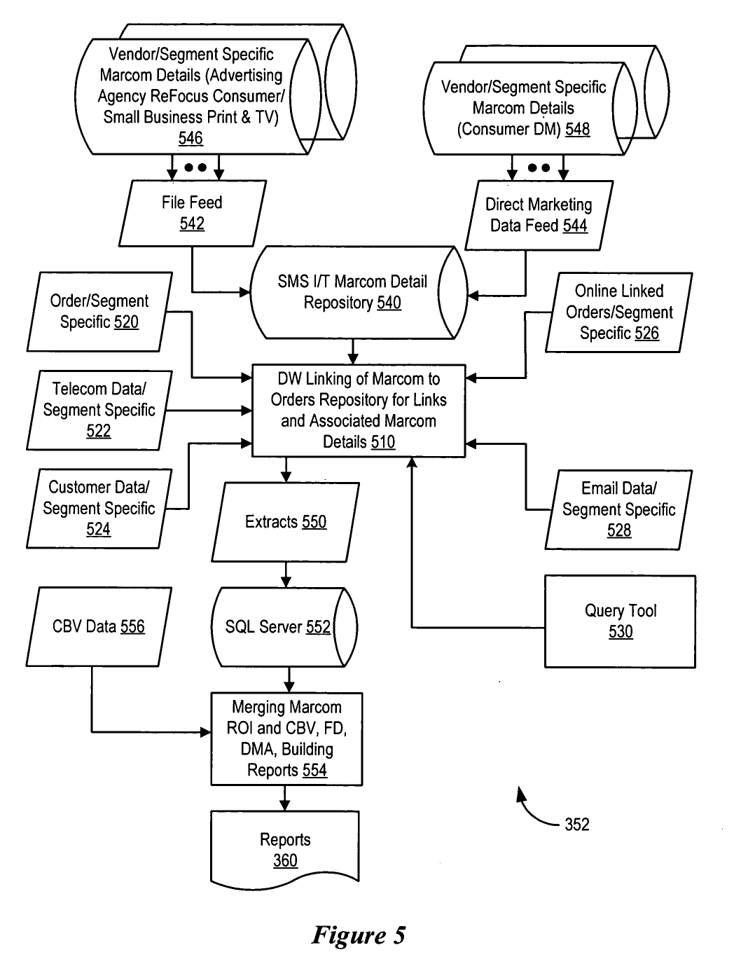

Referring to FIG. 5, a flow diagram of linked data module 352 of the marketing communication return on investment system 120 is shown. More specifically, the marcom ROI data processing module 312 includes a data warehouse (DW) linking repository module 510. The DW linking repository module 510 provides repository information relating to linking of marcom to orders for links and associated marcom details. The DW linking repository module 510 receives (or pulls) order data 520 that is segment specific, telecom data 522 that is segment specific, customer data 524 that is segment specific, online linked order data 526 that is segment specific and email data 528 that is segment specific.

The DW linking repository module 510 receives inputs from a links tool 530 such as a data warehouse database links tool. Thus the DW linking repository module 510 can be queried for results via the data warehouse. The data warehouse performs all of the linking functions and populates any related tables with the results of the links.

Based upon queries, the DW linking repository module 510 receives information from a sales marketing support information technology (SMS IT) marcom detail repository 540. The SMS IT marcom detail repository 540 also receives at least one agency file feed 542 and/or at least one direct marketing data feed 544. The agency file feed 542 receives vendor segment specific marcom details 546 such as print and television marcom details. The direct marketing data feed 544 receives vendor segment specific marcom details 548 such as direct marketing marcom details. The vendor segment specific marcom details 546 include agency consumer and small business print and TV information. The vendor segment specific marcom details 548 include consumer direct marketing information.

The information that is stored within the marcom detail repository 540 and that is provided by the agency file feed 542 and the direct marketing data file feed 548 include price, product and promotional information for each relevant marketing communication. The information that is stored within the marcom detail repository 540 and that is provided by the agency file feed 542 and the direct marketing data file feed 548 also include primary, secondary and tertiary product information for each marketing communication. Thus, when the linking functions are performed, the effectiveness of a marketing communication can be determined based upon price, product and promotion at a primary, secondary and tertiary product level.

The marcom detail repository 540 stores information regarding key creative elements of the various marcom vehicles including pricing product offerings and promotions of each of the marcom vehicles, maintains all details of media purchases including unit sizes and types, circulations, etc.

The DW linking repository module 510 provides an output to an extracts module 550 including marcom details and linked results. The extracts module 550 provides an input to a structured links language (SQL) server 552. The SQL server 552 provides an input to a merge module 554. The merge module 554 also receives an input from a calls by vehicle (CBV) data module 556. The merge module 554 provides an output to the reports module 360. The merge module 554 merges marcom ROI information and calls by vehicle information, financial database (FD) information, direct marketing area information to build reports desired by various business units.

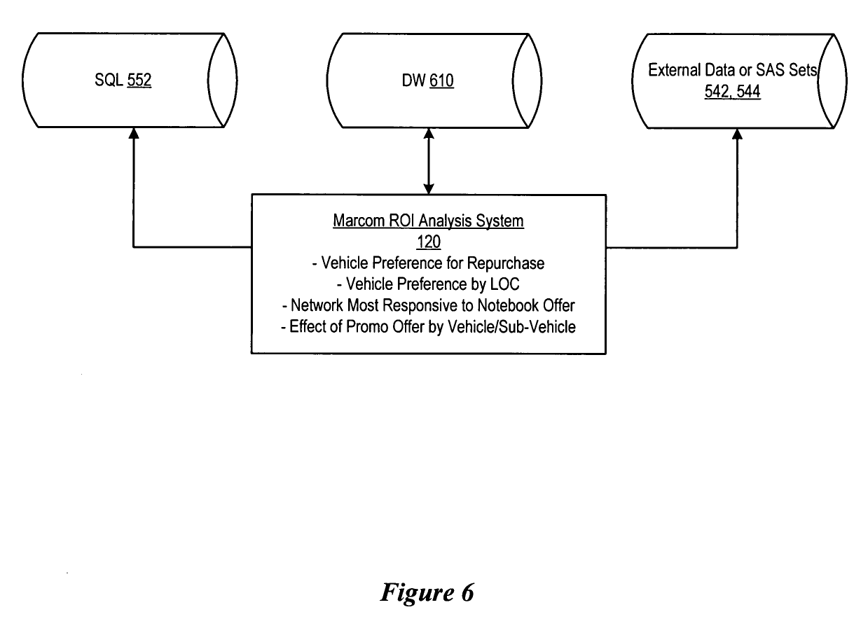

Referring to FIG. 6, a block diagram of an example of the operation of the marcom return on investment system 120 is shown. More specifically the marcom ROI system 120 resides on and interacts with the data warehouse 610. The marcom ROI system 120 links results and financials by business segment as well as a suggested winning marcom along with information regarding margin, revenue and units related to a particular marcom. The results provided by the marcom ROI system 120 include information by marcom vehicle and by segment relating to price, product and promotion. The marcom ROI system 120 provides to results to a database server 552 which can then analyze this information by line of business as well as by segment. The marcom ROI system 120 provides information to external data or statistical analysis software (SAS) sets regarding additional details about customer segment and customer demographics. This external data may be derived from data modelers or statisticians.

Using the marcom ROI system 120, a marcom vehicle preference for repurchase can be identified. The vehicle preference can be by line of business. E.g., the network that is most responsive to a notebook offer or the affect of a particular promotion by vehicle and sub vehicle can be determined by the marcom ROI system 120.

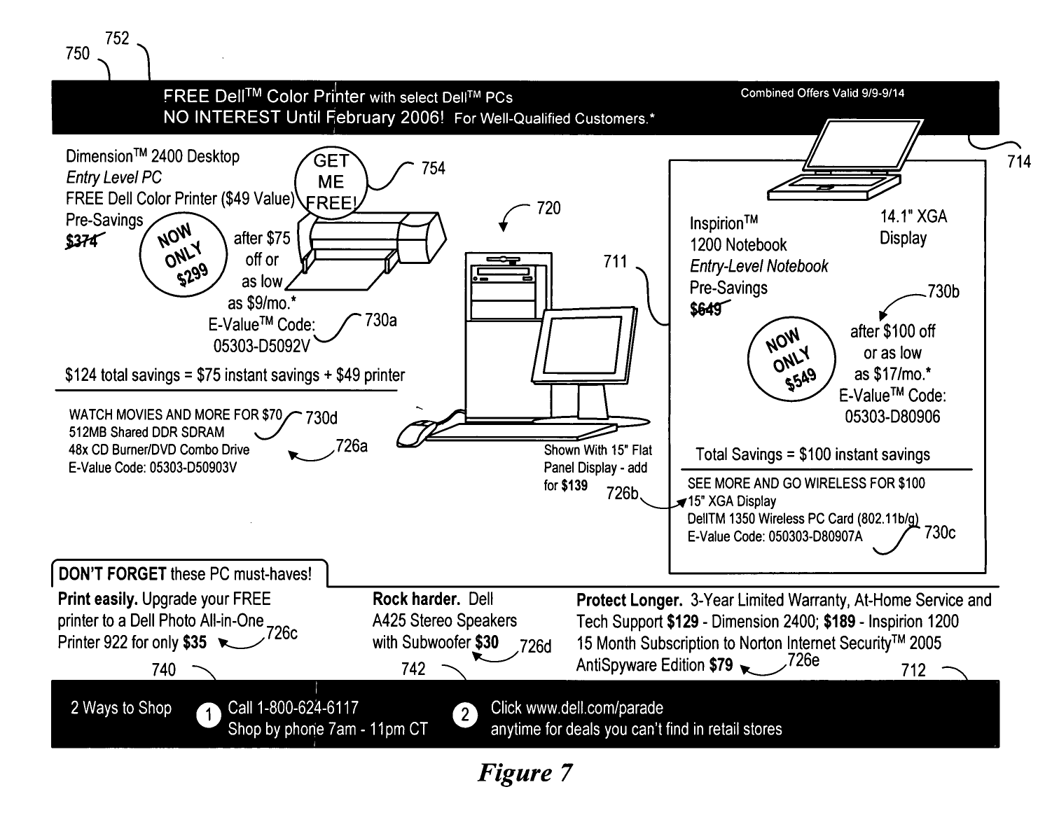

Referring to FIG. 7, an example print type marketing communication is shown. More specifically, print advertising includes a product description portion 710, a contact portion 712 and a promotional portion 714.

The product description portion 710 of the marketing communication includes price information and product information for at least one product. The product description portion 710 can also include promotional information. With the example shown, price and product information is presented for a plurality of products. Price and product information is presented for a primary product, a secondary product and a plurality of tertiary products.

In the example marketing communication shown in FIG. 7, the primary product 720 is a desktop type computer system. The primary product 720 may be recognized within the marketing communication by the most prominent presentation within the marketing communication and often has the lowest system price (e.g., $299) within the marketing communication.

The secondary product 722 is a notebook type computer system. The secondary product 722 may be recognized within the marketing communication by the second most prominent presentation within the marketing communication and often has the second lowest system price (e.g., $599.00) within the marketing communication.

The tertiary products 726a, 726b, 726c, 726d may be recognized within the marketing communication by their relatively lower prices than the primary product 720 and secondary product 722. Tertiary products may also be up-sells of the primary and secondary products. For example, the “watching movies and more” product for $70 in the tertiary product 726a or the “wireless product” for $100 in the tertiary product 726b. Tertiary products may also be somewhat unrelated to the primary product 720 and secondary product 722. For example, in a marketing communication in which the primary and second products are computer systems, a tertiary product might be a music player or a television.

Within the product description portion 710, a plurality of the products for which information is being conveyed include value codes 730a, 730b, 730c, 730d. The value codes 730a, 730b, 730c, 730d provide a customer with a method of identifying a particular product when ordering the product. The value codes correspond to a particular product configuration. In products such as computer systems where many components are variable, it is desirable to provide the manufacturer with a method for identifying a particular product configuration.

The contact portion 712 provides information regarding how to contact the manufacturer to order the products advertised within the marketing communication.

The contact portion 712 can present information regarding a plurality of contact methods. For example, in the example marketing communication, a telephone number contact method 740 is presented as well as an online contact method 742 is presented. Each of these contact methods is unique for the particular marketing communication.

The promotional portion 714 provides promotional information that applies to the entire marketing communication. For example, in the example marketing communication a free product promotion 750 is presented as well as a financing promotion 752 is presented. The free product promotion information 754 is also conveyed within the product information portion 710 of the marketing communication.

It will be appreciated that other types of marketing communications convey price, product and promotional information at different levels including primary, secondary and tertiary levels. Sometimes certain marketing communications such as television marketing communications only include a primary and secondary level.

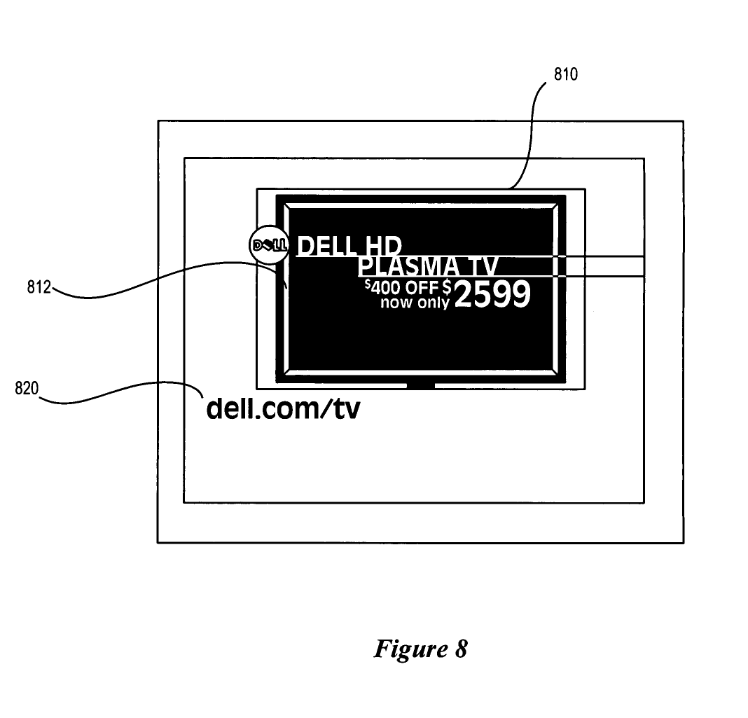

Referring to FIG. 8, an example of a screen presentation 800 for a television marketing communication is shown. More specifically, the screen presentation presents a primary product 810 (e.g., the plasma TV) as well as a promotional offer 812 (e.g., $400 off). The screen presentation also includes information 820 (e.g., dell.com/tv) for identifying this marcom when the advertised product is purchased.

The screen presentation could further include a telephone number for linking this marcom as well as a key code for the advertised product. This screen presentation is accompanied by a voice over which sets forth for example:

Right now save $400 on a Dell 42 inch HD plasma TV

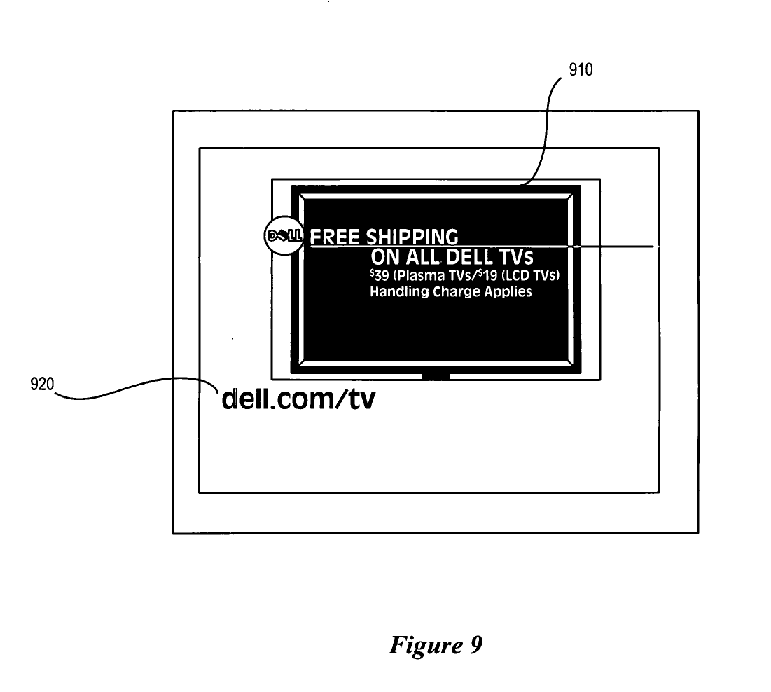

Referring to FIG. 9, another example of a screen presentation 900 of a television marketing communication is shown. More specifically, the screen presentation presents a promotional offer 910 (e.g., Free shipping on all Dell TVs). The screen presentation also includes information 920 (e.g., dell.com/tv) for identifying this marcom when the advertised product is purchased. The screen presentation could further include a telephone number for linking this marcom as well as a key code for the advertised product. This screen presentation is accompanied by a voice over which sets forth for example:

Plus get free shipping.

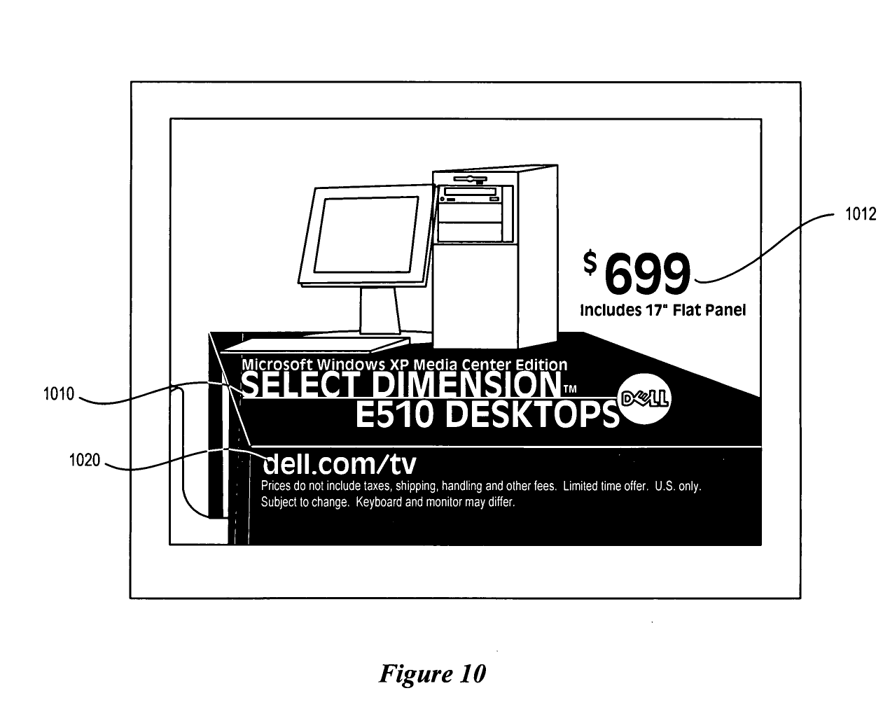

Referring to FIG. 10, another example of a screen presentation 1000 of a television marketing communication is shown. More specifically, the screen presentation presents a secondary product 1010 (e.g., the desktop computer system) as well as a promotional offer 1012 (e.g., an included 17′ flat panel monitor). The screen presentation also includes information 1020 (e.g., dell.com/tv) for identifying this marcom when the advertised product is purchased. The screen presentation could further include a telephone number for linking this marcom as well as a key code for the advertised product. This screen presentation is accompanied by a voice over which sets forth for example:
Get the most out of your home entertainment with a Dell media center PC starting at only $699. Its entertainment made easy with Dell and Microsoft

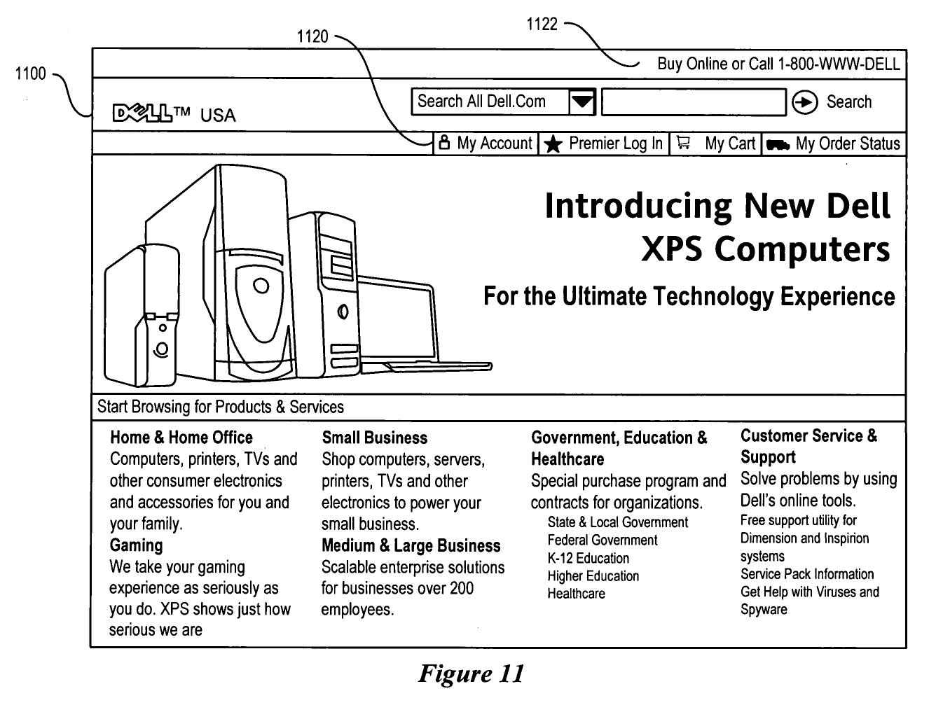

Referring to FIG. 11, an example of an online marketing communication 1100 is shown. Often when a brand has brand recognition, a customer might access the manufacturer's web site merely by entering a broad URL. For example, a customer might access Dell's web site merely by entering dell.com. Accordingly, the Front Page of the website becomes a form of online marketing communication. The Front Page might include a series of images that present various products. A customer can access more information about the product by actuating the image.

Additionally, the Front page 1100 includes a number of features for enabling a marcom ROI system 120 to link a customer order with the appropriate marcom. For example, the Front Page 1110 includes an account indication 1120 which enables a customer to access a customer account. The customer account can then maintain a record of any products that the customer configures. The Front Page 1110 also includes a telephone number 1122 for a customer to call to order products that are presented within the manufacturer website.

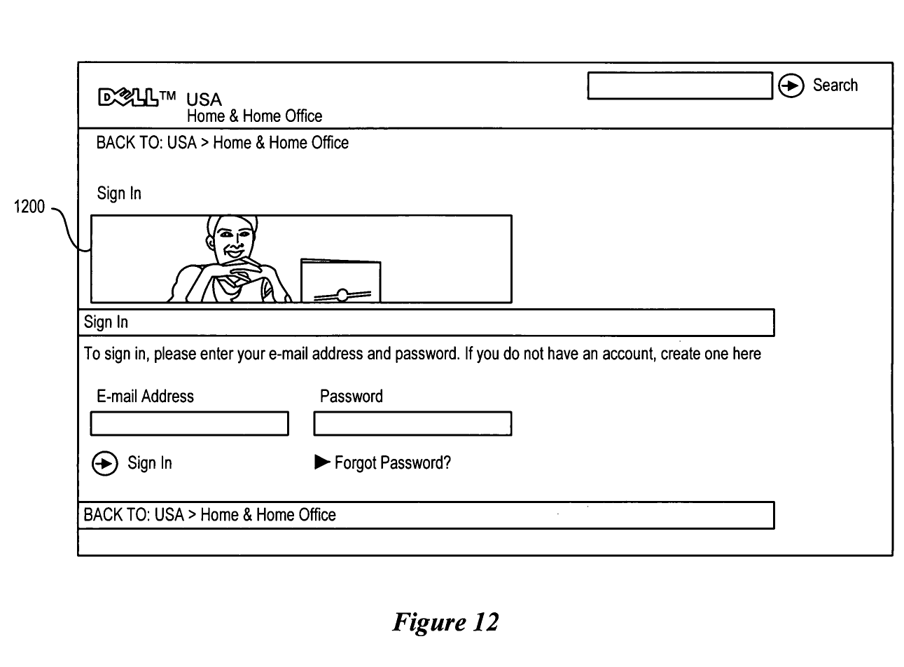

Referring to FIG. 12, another example of an online marketing communication 1200 is shown. More specifically, the website provides a customer with the ability to access a particular customer account. By having a customer account, items that are configured or ordered by the customer can be tracked. The manufacturer might provide incentives to the customer to set up and maintain a customer account. For example, products that are ordered via the account might have a lower shipping rate or might qualify for a particular rebate. The marcom ROI system 120 can use the information that is obtained about particular customer information to link particular marcom to customer orders.

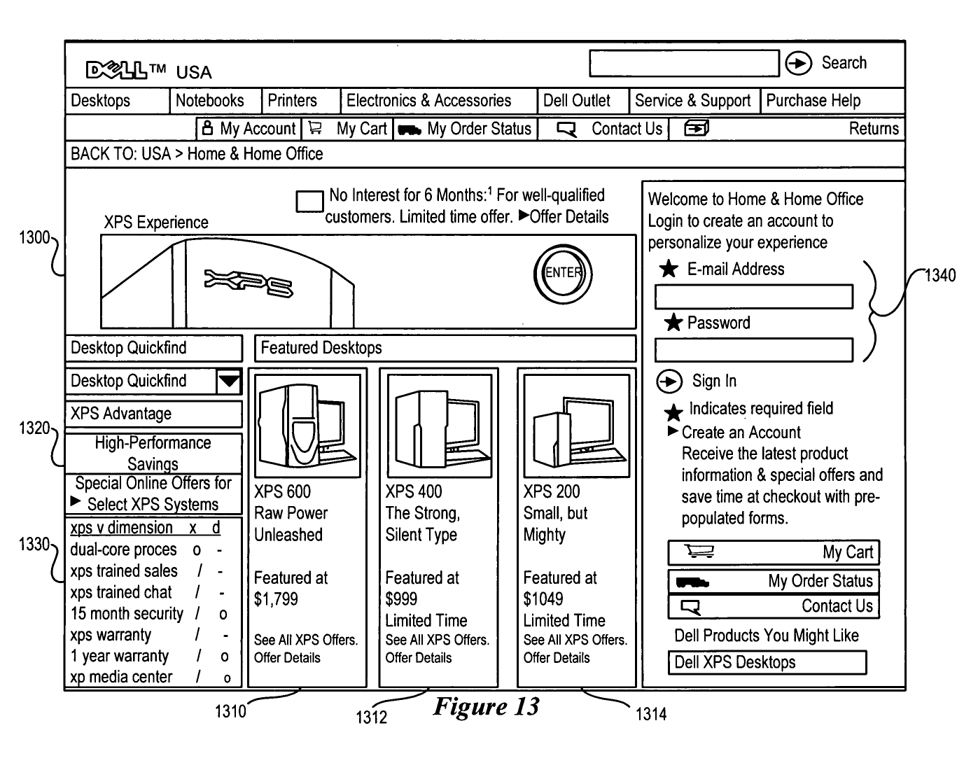

Referring to FIG. 13, another example of an online marketing communication 1300 is shown. More specifically, when a customer actuates an image on the Front Page 1100, the customer might be directed to a more detailed page for the particular type of product. This more detailed page thus becomes a type of online marcom. The web page 1300 includes marcom information for a primary product 1310 as well a one or more secondary products 1312, 1314. The web page 1300 also includes promotional information 1320. The web page may also include information 1330 that assists or encourages a customer to purchase the advertised products. The web page includes a presentation 1340 to enable a customer to access a particular customer account.

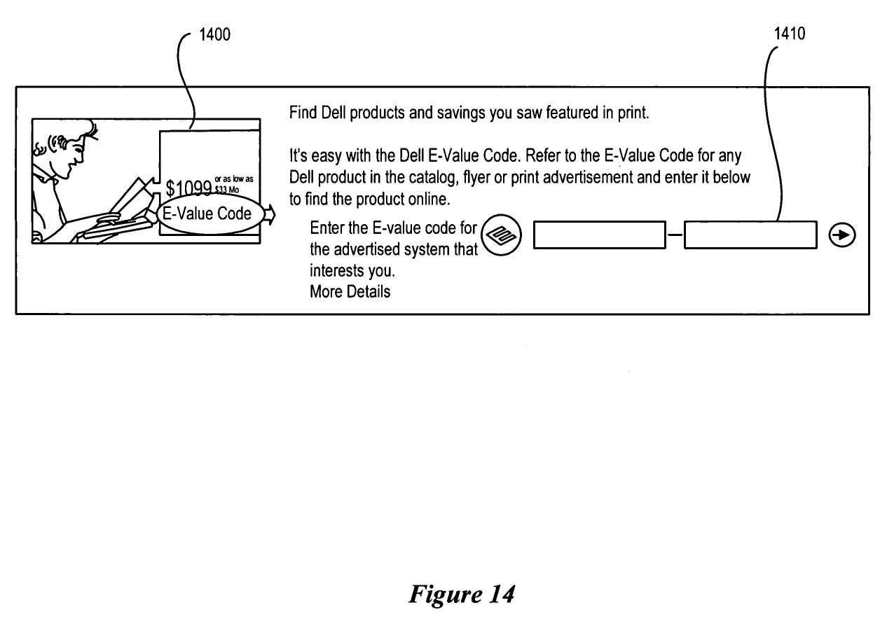

Referring to FIG. 14, another example of an online marketing communication 1400 is shown. One challenge associated with transference occurs when a customer is exposed to a particular type of marcom and then uses another vehicle to order a product. By providing a means for entering key codes 1410, the marcom ROI system can link a customer order with the appropriate marcom. For example, a customer might enter a value code 730a from a product that was presented via a print type marcom when ordering the product via an online type marcom.

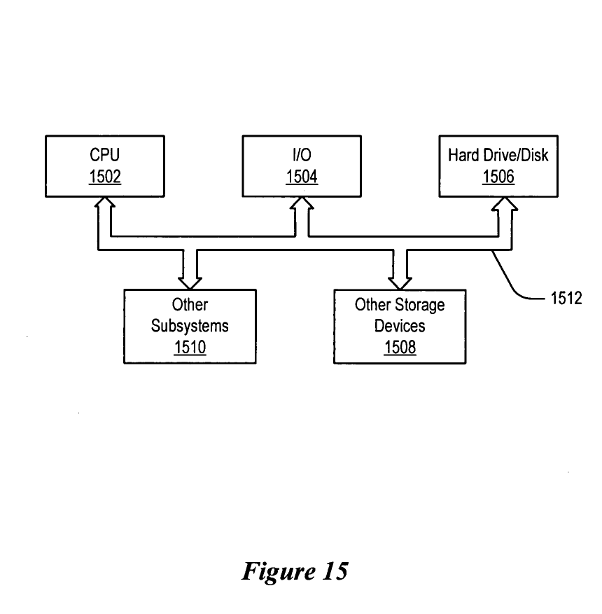

Referring briefly to FIG. 15, a system block diagram of an information handling system 1500 is shown. The information handling system is an example of a product that is produced by the manufacturer. Additionally, the information handling system is an example of a system that executes the marcom ROI system 120. The information handling system 1500 includes a processor 1502, input/output (I/O) devices 1504, such as a display, a keyboard, a mouse, and associated controllers, non-volatile memory 1504 such as a hard disk and drive, and other storage devices 1508, such as a floppy disk and drive and other memory devices, and various other subsystems 1510, all interconnected via one or more buses 1512. When the information handling system is executing the marcom ROI system 120, the marcom ROI system 120 is stored on the non-volatile memory 1504 and executed by the processor 1502.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example as well as large scale data bases or data warehouses. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, while certain types of marcom vehicles have been discussed, other types of vehicles are within the scope of the claims. Billboard marcom or radio marcom are two other examples of marcom that may be used within the marcom ROI system 120. Also, other types of segments are also within the scope of the claims. Any type of profit and loss center for a company could use the marcom ROI system 120 to determine the effectiveness of marcom for that profit and loss center.

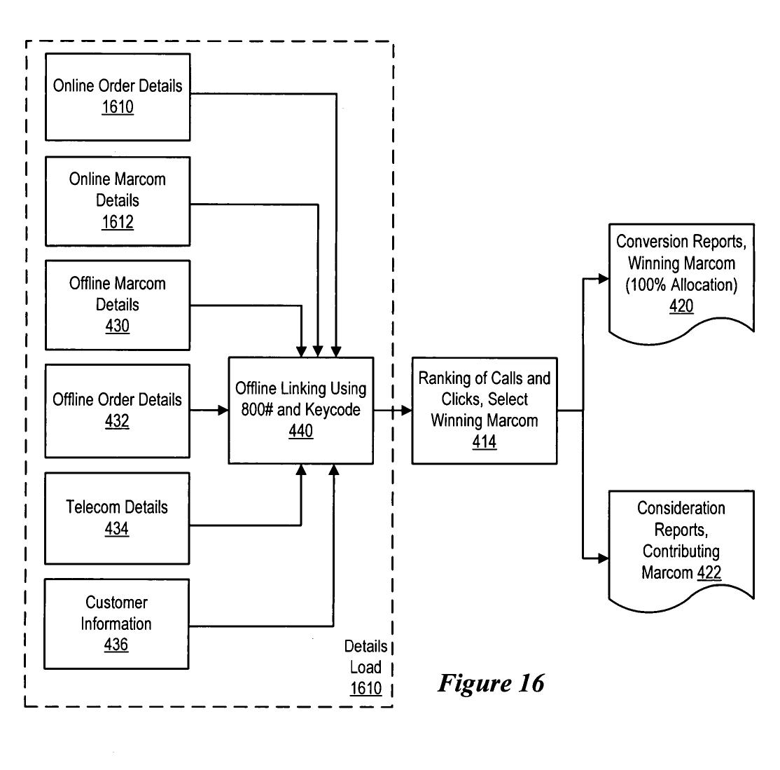

Also for example, referring to FIG. 16, a block diagram of an alternate process flow of order attribution within the marcom ROI system 120 is shown. Within the alternate process flow, online and offline information are both linked within the details load process at step 1610. More specifically, the process starts with a marcom details load process at step 410. During step 1610, the marcom system 120 merges online and offline details.

During the marcom load, the marcom ROI system 120 determines which marcom to link with which orders using for example, the telephone numbers (e.g., various 1600 numbers) used when interacting with the manufacturer or keycodes identified when interacting with the manufacturer.

Next, at step 414, the marcom ROI system 120 generates a ranking of various marcom candidates (e.g., calls and clicks) to provide an indication of a winning marcom. The winning marcom is selected from a list of marcom candidates based upon a plurality of factors such as recency (a marcom vehicle that is closest to the order in terms of time and day) and business rules for each of the marcom candidates.

When ranking the various marcom candidates, the marcom ROI system 120 identifies the contacts leading up to the order (i.e., the contacts that factored into the consideration of the customer making a purchase). For example, with an internet type marcom, the contacts might include select clicks leading up to the order from an online order attribution application (for online orders), select calls leading up to the order (for online and offline type orders). These marcom related calls or clicks that are identified as consideration (that were part of a customer's decision making process), and code links that are not selected as a winner are identified as consideration data (e.g., this information may be inserted into a consideration table).

The ranking generated at step 414 can be used to generate conversion reports 420 as well as consideration reports 422. The conversion reports 420 indicate a winning marcom when considering substantially all related marcom candidates (i.e., with 100% allocation). The consideration reports 422 takes into account contributing marcom. For example, a certain type of marcom might have resulted in a sale, while other types of marcom were presented to a particular customer and are assumed to have contributed to the sale.

During the details load step 410, the marcom system receives information from a variety of online and offline sources and links the information to the appropriate marcom. More specifically, the marcom system 120 receives online order details 1610, online marcom details 1612, offline marcom details 430, offline order details 432, telecom details 434 as well as customer information 436 and links this information using call in number information (such as 1600 number information) and keycode information at step 440 as well as link information. Different marcom vehicles present different call in numbers or keycodes. Thus, based upon particular call in numbers, keycodes and link information, a customer contact may be linked to a particular marcom vehicle.

Consequently, the invention is intended to be limited only by the spirit and scope of the appended claims, giving full cognizance to equivalents in all respects.

What is claimed is:

1. A method for analyzing television marketing communication effectiveness comprising:
providing a television marketing communication with identification information, price information and product information for a primary product and a secondary product;
linking an order with the television marketing communication via the marketing communication identification information; and,
determining, via a marketing communication system, marketing communication effectiveness for the television marketing communication.

2. The method of claim 1 wherein:
the marketing communication effectiveness relates to a return on investment for marketing communication expenditures.

3. The method of claim 1 wherein:
the marketing communication effectiveness relates to financial details for marketing communication expenditures.

4. The method of claim 3 wherein:
the financial details include information relating to units margin and revenue for marketing communication expenditures for the primary product and the secondary product.

5. The method of claim 1 wherein:
the marketing communication system includes a television module, the television module determining the effectiveness of television marketing communications.

6. The method of claim 1 wherein:
the linking includes tracking information regarding creative elements of the marketing communication.

7. The method of claim 6 wherein:
the creative elements include at least one of pricing product offerings and promotions for the marketing communication, details of media planning of the marketing communication and buying information of the marketing communication.

8. A method for analyzing online marketing communication effectiveness comprising:
providing an online marketing communication with identification information, price information and product information for a primary product and a secondary product;
linking an order with the online marketing communication via the marketing communication identification information; and,
determining, via a marketing communication system, marketing communication effectiveness for the online marketing communication.

9. The method of claim 8 wherein:
the marketing communication effectiveness relates to a return on investment for marketing communication expenditures.

10. The method of claim 8 wherein:
the marketing communication effectiveness relates to financial details for marketing communication expenditures.

11. The method of claim 10 wherein:
the financial details include information relating to units margin and revenue for marketing communication expenditures for the primary product and the secondary product.

12. The method of claim 8 wherein:
the marketing communication system includes an online module, the online module determining the effectiveness of online marketing communications.

13. The method of claim 8 wherein:
the linking includes tracking information regarding creative elements of the marketing communication.

14. The method of claim 13 wherein:
the creative elements include at least one of pricing product offerings and promotions for the marketing communication, details of media planning of the marketing communication and buying information of the marketing communication.

15. An apparatus for analyzing television marketing communication effectiveness comprising:
means for providing a television marketing communication with identification information, price information and product information for a primary product and a secondary product;
means for linking an order with the television marketing communication via the marketing communication identification information; and,
a marketing communication system, the marketing communication system determining marketing communication effectiveness for the television marketing communication.

16. The apparatus of claim 15 wherein:
the marketing communication effectiveness relates to a return on investment for marketing communication expenditures.

17. The apparatus of claim 15 wherein:
the marketing communication effectiveness relates to financial details for marketing communication expenditures.

18. The apparatus of claim 17 wherein:
the financial details include information relating to units margin and revenue for marketing communication expenditures for the primary product and the secondary product.

19. The apparatus of claim 15 wherein:
the marketing communication system includes a television module, the television module determining the effectiveness of television marketing communications.

20. The apparatus of claim 15 wherein:
the linking includes tracking information regarding creative elements of the marketing communication.

21. The apparatus of claim 20 wherein:
the creative elements include at least one of pricing product offerings and promotions for the marketing communication, details of media planning of the marketing communication and buying information of the marketing communication.

22. An apparatus for analyzing online marketing communication effectiveness comprising:
means for providing an online marketing communication with identification information, price information and product information for a primary product and a secondary product;
means for linking an order with the online marketing communication via the marketing communication identification information; and,
a marketing communication system, the marketing communication system determining marketing communication effectiveness for the online marketing communication.

23. The apparatus of claim 22 wherein:
the marketing communication effectiveness relates to a return on investment for marketing communication expenditures.

24. The apparatus of claim 22 wherein:
the marketing communication effectiveness relates to financial details for marketing communication expenditures.

25. The apparatus of claim 24 wherein:
the financial details include information relating to units margin and revenue for marketing communication expenditures for the primary product and the secondary product.

26. The apparatus of claim 22 wherein:
the marketing communication system includes an online module, the online module determining the effectiveness of online marketing communications.

27. The apparatus of claim 22 wherein:
the linking includes tracking information regarding creative elements of the marketing communication.

28. The apparatus of claim 27 wherein:
the creative elements include at least one of pricing product offerings and promotions for the marketing communication, details of media planning of the marketing communication and buying information of the marketing communication.
